(19) United States
(12) Patent Application Publication
(10) Pub. No.: US 2014/0350826 A1
(43) Pub. Date: Nov. 27, 2014

(54) ENGINE START CONTROL SYSTEM FOR VEHICLE WITH ISG AND METHOD THEREOF

(71) Applicants: Kia Motors Corporation, Seoul (KR); Hyundai Motor Company, Seoul (KR)

(72) Inventor: Young Seog HAN, Yongin-si (KR)

(73) Assignees: Kia Motors Corporation, Seoul (KR); Hyundai Motor Company, Seoul (KR)

(21) Appl. No.: 14/137,088

(22) Filed: Dec. 20, 2013

(30) Foreign Application Priority Data
May 27, 2013 (KR) 10-2013-0059835

(51) Int. Cl. F02D 41/06

(52) U.S. Cl. CPC F02D 41/065
USPC 701/113

(57) ABSTRACT

An engine starting control method of vehicle with an ISG may include determining whether a request of restarting an engine is detected in an idle stop state; determining a cylinder closest to TDC from an angle of a crankshaft when the request of restarting the engine is detected; and starting a cranking operation by operation of the ISG, and restarting the engine by controlling a starting fuel injection amount and ignition timing of the cylinder closest to TDC.

### CROSS-REFERENCE TO RELATED APPLICATION

The present application claims priority to Korean Patent Application No. 10-2013-0059835 filed on May 27, 2013, the entire contents of which is incorporated herein for all purposes by this reference.

### BACKGROUND OF THE INVENTION

1. Field of the Invention

The present invention is related to a vehicle with ISG (Idle Stop and Go). More particularly, the present invention relates to an engine start control system for a vehicle with ISG and a method thereof that optimizes data of an EMS (Engine Management System) and decreases starting time and noise when engine restarting is requested after the engine is idle stopped.

2. Description of Related Art

According to a continuous demand for improvement of fuel efficiency for a vehicle and stricter regulations of discharge gas of many countries, demand for an environmentally friendly vehicle has increased, and ISG has been provided as a realistic alternative for the demand.

An ISG receives information, such as speed of a vehicle and speed of an engine, and if the vehicle stopped for more than a predetermined amount of time in an idle condition, the ISG stops the engine. Therefore fuel consumption is enhanced.

After such idle stop, the engine is started when a driver displays a starting intention or the vehicle condition satisfies a restarting condition.

That is, while a vehicle travels, the ISG automatically stops the engine when the engine idles after a short time stoppage according to a signal, and the ISG restarts the engine when a driver displays a restarting intention, such as operation of an accelerator pedal. Therefore, the ISG provides enhancement of fuel economy of about 5-15.

FIG. 4 shows a graph measuring a starting control signal of a conventional vehicle with ISG.

As shown in FIG. 4, in an idle stop state, a starting control signal is on according to a request to restart the engine, and thereby a cranking operation is performed by operation of the ISG. Fuel injection is started after 0.27 seconds have passed after the cranking operation is started, and it takes about 0.63 seconds to reach idle rotation speed that is determined to be completion of the starting operation of the engine.

When the engine speed reaches about 570 RPM, the cranking operation is stopped.

As described, according to a conventional vehicle, when restarting the engine from an idle stop state, a time for determination of a cylinder for fuel injection control and ignition timing control is delayed. Therefore, the starting time is delayed and thus is excessively long, which provides an uneasy feeling to the driver.

Further, since the engine speed for stopping the cranking operation is set to about 570 RPM, there is a problem that cranking noise can occur.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine start control system for a vehicle with ISG having advantages of determining a cylinder closest to Top Dead Center (TDC) when engine restarting is requested after idle stop, and controlling fuel injection and ignition timing, thereby reducing a starting time.

Also, the present invention provides improvement of an engine noise by optimizing a stop point of a cranking operation.

In an aspect of the present invention, an engine start control system for a vehicle with ISG may include, a driving information detection unit detecting status information which is necessary to drive a vehicle, an ISG operating as a motor in a restarting condition so as to perform a cranking operation, and operating as a generator in a charging condition so as to charge a battery, a fuel injection unit injecting fuel to a cylinder in a compression stroke, an ignition unit igniting a fuel in the cylinder being in the compression stroke, and a control unit determining a cylinder closest to TDC from an angle of a crankshaft when detecting a request of restarting an engine in an idle stop state, controlling fuel injection and ignition timing of the determined cylinder, and restarting the engine.

The driving information detection unit may include, an engine speed detection unit detecting an engine speed, a battery detection unit detecting a state of charge (SOC), a crank angle detection unit detecting a change of an angle of the crankshaft, a brake detection unit detecting operation of a brake pedal, a vehicle speed detection unit detecting a vehicle speed, and an accelerator pedal detection unit detecting operation of an accelerator pedal.

The control unit determines that restarting the engine is requested when an SOC of a battery is less than a reference charging amount or when operation of an accelerator pedal is detected.

The control unit stops cranking operation when an engine speed exceeds a reference RPM in a state of engine restarting.

In addition, a starting control method of a vehicle with an ISG according to another exemplary embodiment of the present invention may include, determining whether a request of restarting an engine is detected in an idle stop state, determining a cylinder closest to TDC from an angle of a crankshaft when the request of restarting the engine is detected, and starting a cranking operation by operation of the ISG, and restarting the engine by controlling a starting fuel injection amount and ignition timing of the cylinder closest to TDC.

The cranking operation is stopped when an engine speed exceeds a reference RPM (350 RPM) due to the restart of the engine.

It is determined that the request of restarting the engine is detected when an SOC of a battery is less than a reference charging amount or when operation of an accelerator pedal is detected.

According to the present invention, a starting time from idle stop to engine restarting is shortened by about 0.21 seconds by optimizing EMS data, and therefore a delay of engine starting is improved.

Also, according to the present invention, a starting tone is improved by about 15.6% by optimizing a stopping time of a cranking operation after restarting, and a rattle of the engine is solved, thereby safety and reliability are improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 schematically shows an engine starting control system for a vehicle with ISG according to an exemplary embodiment of the present invention.

FIG. 2 shows a flowchart of a starting control process of a vehicle with ISG according to the exemplary embodiment of the present invention.

FIG. 3 shows a graph measuring a starting control signal of a vehicle with ISG according to the exemplary embodiment of the present invention.

FIG. 4 shows a graph measuring a starting control signal of a conventional vehicle with ISG.

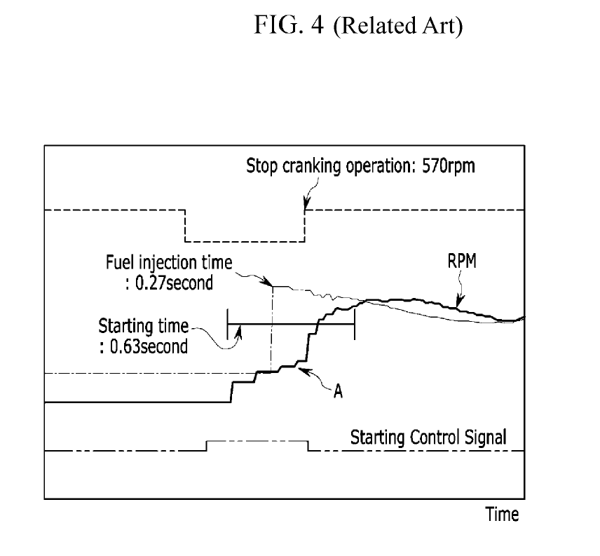

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Also, the size and thickness of each element are arbitrarily shown in the drawings, but the present invention is not necessarily limited thereto, and in the drawings, the thickness of layers, films, panels, regions, etc., are exaggerated for clarity.

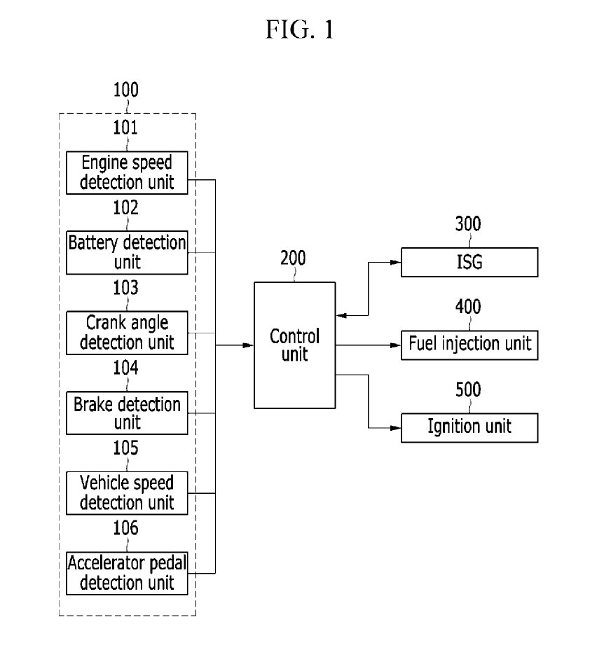

FIG. 1 schematically shows a starting control system for a vehicle with ISG according to an exemplary embodiment of the present invention.

Referring to FIG. 1, an exemplary embodiment of the present invention includes a driving information detection unit 100, a control unit 200, an ISG 300, a fuel injection unit 400 and an ignition unit 500.

The driving information detection unit 100 detects overall status information which is necessary to drive a vehicle, including an engine speed, a state of charge, a crankshaft angle, application of a brake pedal, application of an accelerator pedal, a vehicle speed, and a coolant temperature. The driving information detection unit 100 transforms the status information to electric signals, and provides the signals to the control unit 200.

The driving information detection unit 100 includes an engine speed detection unit 101 detecting the engine speed, a battery detection unit 102 detecting the SOC (state of charge) of a battery, a crank angle detection unit 103 detecting a change of a crankshaft angle, a brake detection unit 104 detecting operation of the brake pedal, a vehicle speed detection unit detecting vehicle speed, and an accelerator pedal detection unit 106 detecting operation of the accelerator pedal.

The control unit 200 determines whether engine restart is requested when the SOC of the battery is less than a standard charging amount or when operation of the accelerator pedal is detected, and determines a cylinder closest to TDC from the angle of the crankshaft.

The control unit 200 operates the ISG 300 so as to start the cranking operation when the engine restart is requested and when the cylinder closest to TDC is determined, controls the fuel injection unit 400 so as to inject a calculated starting fuel amount to the cylinder closest to TDC, and controls the ignition unit 500 so as to ignite fuel in the cylinder closest to TDC.

The control unit 200 detects the engine speed while the engine is restarted, and stops the cranking operation when the engine speed exceeds a predetermined reference rotation speed (350 RPM).

The ISG 300 operates as a motor or a generator by control of the control unit 200. That is, the ISG 300 operates as a motor in a restarting condition so as to perform a cranking operation, and operates as a generator in a charging condition so as to charge the battery.

The fuel injection unit 400 is formed with injectors, and injects a calculated starting fuel amount to a cylinder in a compression stroke under control of the control unit 200.

The ignition unit 500 ignites fuel in the cylinder in the compression stroke under control of the control unit 200.

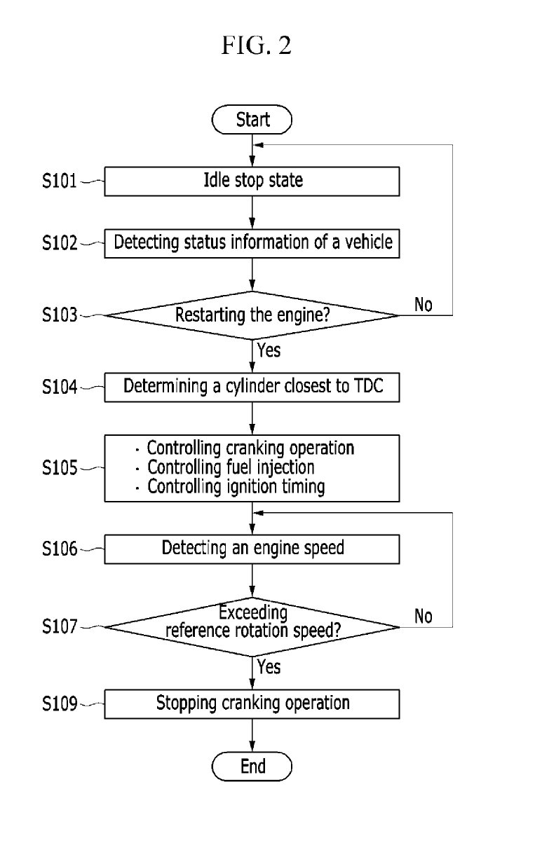

Referring to FIG. 2, the operation of the present invention as described above is as follows.

The present invention is a control method for restarting an engine of a vehicle with ISG, and a control method for performing idle stop is well known to those skilled in the art, and therefore a detailed description is omitted.

When the vehicle with ISG according to the present invention enters an idle stop state in accordance with a standby signal while driving (S101), the driving information detection unit 100 detects overall status information which is necessary to drive the vehicle including the engine speed, the state of charge, the crankshaft angle, operation of the brake pedal, operation of the accelerator pedal, and the vehicle speed at step S102. The driving information detection unit 100 transforms the status information to electric signals, and provides the signals to the control unit 200.

The control unit 200 analyzes the status information of the vehicle detected at step S102, and determines that a request for restarting the engine is detected when the SOC of the battery is less than a reference amount of charge, for example, under 45%, or operation of the accelerator pedal is detected, at step S103.

The control unit 200 returns to step S101 when the request to restart the engine is not detected, and thereby maintains the idle stop state. The control unit 200 determines a cylinder closest to TDC (S104) from the change of crankshaft angle when the request of restarting the engine is detected.

The control unit 200 operates the ISG 300 as a motor and starts the cranking operation for restarting the engine when the cylinder closest to TDC is determined, controls the fuel injection unit 400 so as to inject a calculated starting fuel amount to the cylinder closest to TDC, and controls the ignition unit 500 so as to ignite fuel in the cylinder closest to TDC and thus performs restarting of the engine (S105).

At step S106, the control unit 200 detects the engine speed according to the engine restarting at step S105, and determines whether the engine speed exceeds a predetermined reference rotation speed, for example 350 RPM, at step S107.

The control unit 200 returns to step S106 when the engine speed does not exceed the predetermined reference rotation speed, for example 350 RPM, and stops the cranking operation when the engine speed exceeds the predetermined reference rotation speed, at step S109.

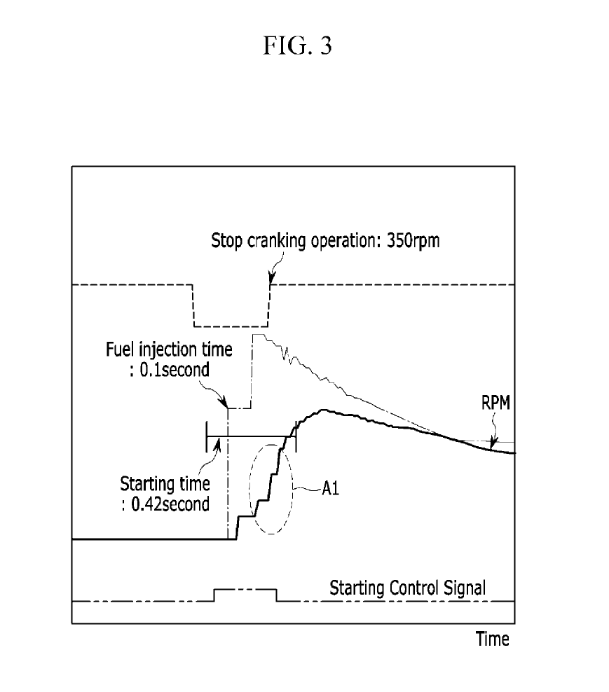

As shown in FIG. 3, in the idle stop state, a starting control signal is on according to the request of restarting the engine, thereby the cranking operation is performed by operation of the ISG 300. The fuel injection is started when 0.1 second has passed after the cranking operation is started, and it takes about 0.42 seconds to reach the idle rotation speed determined to be the end of starting.

Conventionally, a restarting time is about 0.63 seconds. However, according to an exemplary embodiment of the present invention, the restarting time is about 0.42 seconds. Accordingly, compared to the prior art, the restarting time is shortened be about 0.21 seconds, and thus the delay of start is improved.

According to the present invention, the cranking operation is stopped when the engine speed reaches 350 RPM. Therefore, compared to the prior art in which the cranking operation is stopped when the engine speed reaches 570 RPM, the starting tone is improved about by 15.6%. Also, a rattle of the engine is solved, and thereby safety and reliability are improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A starting control apparatus of a vehicle with an Idle Stop and Go (ISG) comprising:
a driving information detection unit detecting status information which is necessary to drive the vehicle;
an ISG operating as a motor in a restarting condition so as to perform a cranking operation, and operating as a generator in a charging condition so as to charge a battery;
a fuel injection unit injecting a fuel to a cylinder in a compression stroke;
an ignition unit igniting the fuel in the cylinder in the compression stroke; and
a control unit determining the cylinder closest to Top Dead Center (TDC) from an angle of a crankshaft when detecting a request of restarting an engine in an idle stop state, controlling fuel injection and ignition timing of the determined cylinder, and restarting the engine.

2. The starting control apparatus of claim 1, wherein the driving information detection unit comprises:
an engine speed detection unit detecting an engine speed;
a battery detection unit detecting a state of charge (SOC);
a crank angle detection unit detecting a change of an angle of the crankshaft;
a brake detection unit detecting operation of a brake pedal;
a vehicle speed detection unit detecting a vehicle speed; and
an accelerator pedal detection unit detecting operation of an accelerator pedal.

3. The starting control apparatus of claim 1, wherein the control unit determines that restarting the engine is requested when an SOC of a battery is less than a reference charging amount or when operation of an accelerator pedal is detected.

4. The starting control apparatus of claim 1, wherein the control unit stops a cranking operation when an engine speed exceeds a reference RPM in a state of engine restarting.

5. A starting control method of a vehicle with an Idle Stop and Go (ISG) comprising:
determining whether a request of restarting an engine is detected in an idle stop state;
determining a cylinder closest to Top Dead Center (TDC) from an angle of a crankshaft when the request of restarting the engine is detected; and
starting a cranking operation by operation of the ISG, and restarting the engine by controlling a starting fuel injection amount and ignition timing of the cylinder closest to TDC.

6. The starting control method of claim 5, wherein the cranking operation is stopped when an engine speed exceeds a reference RPM due to restart of the engine.

7. The starting control method of claim 5, wherein it is determined that the request of restarting the engine is detected when a state of charge (SOC) of a battery is less than a reference charging amount or when operation of an accelerator pedal is detected.

8. A starting control apparatus of a vehicle comprising:
a driving information detection apparatus detecting state information when the vehicle runs;
an Idle Stop and Go (ISG) performing a cranking operation of an engine under a restarting condition, and performing a charging operation of a battery under a charging condition;
a fuel injection unit injecting fuel to each cylinder;
an ignition unit igniting the fuel in the each cylinder; and
a control unit controlling the ISG, the ignition unit, and the fuel injection unit and performing restart of the engine when a request of restarting the engine is detected,
wherein the control unit performs the restart of the engine by the method of claim 5 executed by a predetermined program, and thereby decreases starting time, noise, and vibration.
